(19) United States
(12) Patent Application Publication
(10) Pub. No.: US 2010/0213100 A1
(43) Pub. Date: Aug. 26, 2010

(54) CLEAR-VIEW PACKAGING SYSTEM

(76) Inventors: Bryan Wilks, Jenks, OK (US); Sean Kelly, El Paso, TX (US)

Correspondence Address: Hall, Estill, Hardwick, Gable, Golden &;Nelson, P.C., 100 North Broadway, Chase Tower, Suite 2900, Oklahoma City, OK, 73102, US

(21) Appl. No.: 12/771,436

(22) Filed: Apr. 30, 2010

Related U.S. Application Data
(63) Continuation-in-part of application No. 12/579,999, filed on Oct. 15, 2009.
(60) Provisional application No. 61/196,148, filed on Oct. 15, 2008.

(51) Int. Cl. B65D 25/54; B65D 6/00; B26D 7/00

(52) U.S. Cl. 206/778; 220/4.27; 53/396

(57) ABSTRACT

The present invention relates to a clear-view packaging system for packaging a product. The clear-view packaging system comprising a bottom tray for receiving the product, the bottom tray having a base portion and a plurality of edge portions. Further, the clear-view packaging system includes a top tray disposed on the top of the product, the top tray having a base portion, a plurality of edge portions and a plurality of horizontal top tray corners. The clear-view packaging system also includes at least one strip of banding for securing the bottom tray, the product and the top tray together wherein a lifting member of a lift vehicle can be positioned between at least one of the plurality of edge portions of the top tray and the product so that the product can be lifted and transported.

### CROSS-REFERENCE TO RELATED APPLICATIONS

This application is a continuation-in-part of U.S. Ser. No. 12/579,999, filed on Oct. 15, 2009, which claims priority to U.S. Provisional Patent Application Ser. No. 61/196,148, filed Oct. 15, 2008 the contents of which are hereby incorporated by reference in their entirety.

### BACKGROUND OF THE INVENTION

1. Field of the Invention

The present invention relates generally to a system for packaging goods or products whereby the products or goods are visible and less materials are needed to package the products or goods.

2. Description of the Related Art

Typically, larger goods or products are packaged and shipped in a packaging system that requires a top cap, a bottom cap and a tube portion to be constructed from cardboard, or other non-translucent and/or more expensive materials. This made for a packaging system where the good or product cannot be seen while being handled and shipped. Additionally, it took considerable amounts of packaging material to create the previous packaging systems.

Accordingly, there is a need in the industry to provide a packaging system that reduces costs by using less material while permitting the product or good to be visible during shipping and handling.

### SUMMARY OF THE INVENTION

The present invention relates to a method of packaging a product. The method comprises the steps of providing a product to be packaged. Once a product is provided, a bottom tray for receiving the product is implemented. The bottom tray includes a base portion and a plurality of edge portions. A top tray is provided on top of the product. The top tray includes a base portion, a plurality of edge portions and a plurality of horizontal top tray corners. Finally, at least one strip of banding is disposed around the bottom tray, the product and the top tray to secure them together wherein a lifting member of a lift vehicle can be positioned between at least one of the plurality of edge portions of the top tray and the product so that the product can be lifted and transported

In another embodiment, the present invention relates to a clear-view packaging system for packaging a product. The clear-view packaging system comprising a bottom tray for receiving the product, the bottom tray having a base portion and a plurality of edge portions. Further, the clear-view packaging system includes a top tray disposed on the top of the product, the top tray having a base portion, a plurality of edge portions and a plurality of horizontal top tray corners. The clear-view packaging system also includes at least one strip of banding for securing the bottom tray, the product and the top tray together wherein a lifting member of a lift vehicle can be positioned between at least one of the plurality of edge portions of the top tray and the product so that the product can be lifted and transported.

### BRIEF DESCRIPTION OF THE DRAWINGS

FIG. 1 shows a perspective view of a clear-view packaging system constructed in accordance with the present invention.

FIG. 2 shows another embodiment of the clear-view packaging system constructed in accordance with the present invention.

FIG. 3 shows a perspective view of a bottom tray of the clear-view packaging system constructed in accordance with the present invention.

FIG. 4 shows a perspective view of a top tray of the clear-view packaging system constructed in accordance with the present invention.

FIG. 5 shows another embodiment of the clear-view packaging system constructed in accordance with the present invention.

FIG. 6 shows another embodiment of the top tray of the clear-view packaging system constructed in accordance with the present invention.

### DETAILED DESCRIPTION OF THE INVENTION

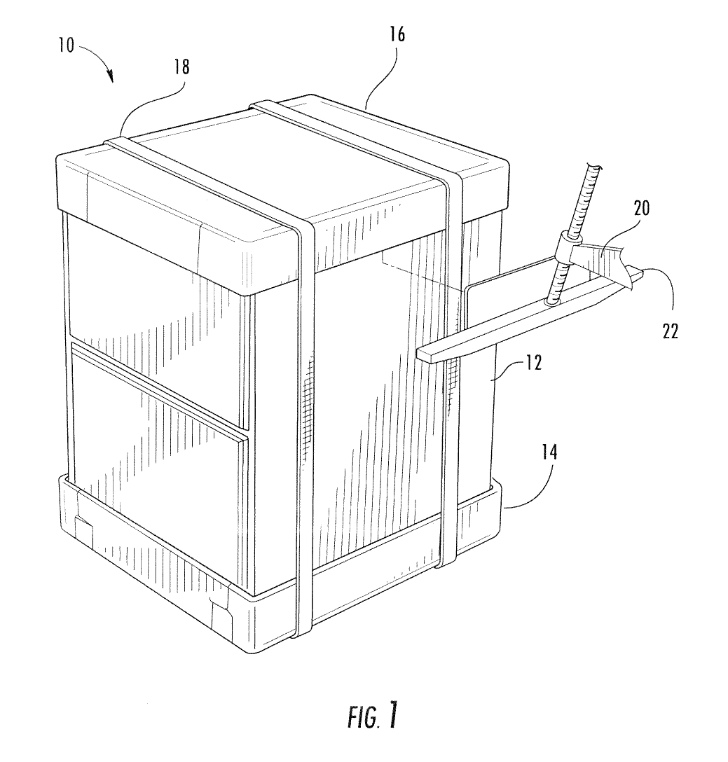

The present invention relates to a clear-view packaging system 10 for packaging larger products 12 (or goods) for storage or transport. Examples of products include, but are not limited to, furnaces, AC units, household appliances, and the like. Referring now to the drawings, and more particular to FIG. 1, shown therein is the clear-view packaging system 10 constructed in accordance with the present invention. In one embodiment of the present invention, the clear-view packaging system 10 includes a bottom tray 14 for receiving the product 12, a top tray 16 disposed on top of the product 12 and at least one strip of banding 18 for securing the bottom tray 14, product 12 and top tray 16 together. The top tray 16 is also designed such that a lift vehicle 20 equipped with a lifting member 22 can lift the product 12 implementing the clear-view packaging system 10. Examples of lift vehicles 20 include, but are not limited to, fork lifts, fork trucks, lift trucks, hand operated lift trucks, and the like.

It should be understood and appreciated that the banding 18 incorporated into the clear-view packaging system 10 of the present invention can by constructed of any material known in the art capable of being fastened together and sustaining the weight of the product 12. Examples of materials include, but are not limited to, nylon, polymeric material, various metals, polyester, and the like.

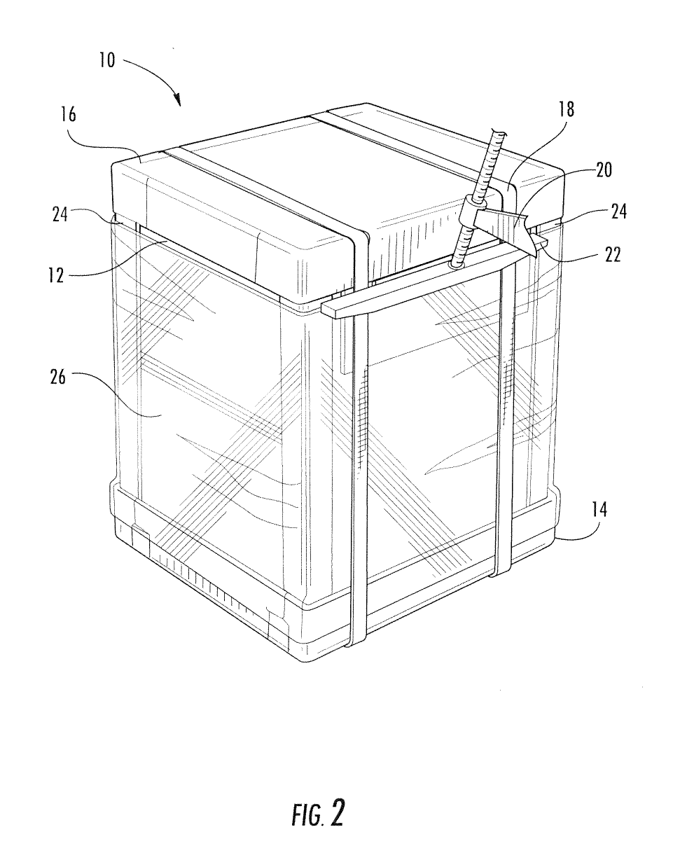

Shown in FIG. 2 is another embodiment of the present invention. In this embodiment, the clear-view packaging system 10 further includes a plurality of vertical support members 24 to support the top tray 16 and distribute the weight and pressure provided by any other object (any other goods or products) that would be stacked upon the product 12 onto the vertical support members 24. Additionally, the clear-view packaging system 10 includes a protective layer 26 that can be disposed on the outside of the product 12 prior to implementing the other elements of the clear-view packaging system 10 or the protective layer 26 can be disposed around the product 12 in any step of the implementation of the clear-view packaging system 10. In one embodiment of the present invention, the protective layer 26 can be a transparent stretch-wrap polymer film. In another embodiment, the protective layer 26 can be any type of transparent material capable of being wrapped around the product 12 or incorporated with the other elements of the clear-view packaging system 10 It should be understood and appreciated that the protective layer 26 can any material known in the art for wrapping products and protecting products from various elements.

The bottom tray 14 of the present invention is shown in more detail in FIG. 3. In one embodiment of the present invention, the bottom tray 14 includes a base portion 28 for protecting the underside of the product 12 and a plurality of edge portions 30 extending from the base portion 28 of the bottom tray 14 to receive the product 12. The base portion 28 and the edge portions 30 of the bottom tray 14 cooperate to form a plurality of horizontal bottom tray corners 32. The edge portions 30 and the base portion 28 are both sized to fit any desired product 12. It should be understood that the edge portions 30 can be any desired length based up on the product's 12 dimensions and desired amount of material used to construct the edge portions 30 of the bottom tray 14.

In another embodiment of the present invention, the bottom tray 14 is further provided with at least one notch portion 34 disposed on at least one of the plurality of horizontal bottom tray corners 32 for receiving the banding 18. In another embodiment of the present invention, there are a plurality of notch portions 34 symmetrically disposed on a plurality of horizontal bottom tray corners 32 so the banding 18 is symmetrically disposed about the product 12. In one example, there are two notch portions 34 on one of the horizontal bottom tray corners 32 and two notch portions 34 symmetrically disposed on another one of the horizontal bottom tray corners 32 on the opposite side of the product 12. This permits the banding 18 to be symmetrically disposed about the product 12 and prohibits the banding 18 form sliding out of position or off the product 12, thus providing balance to the clear-view packaging system 10.

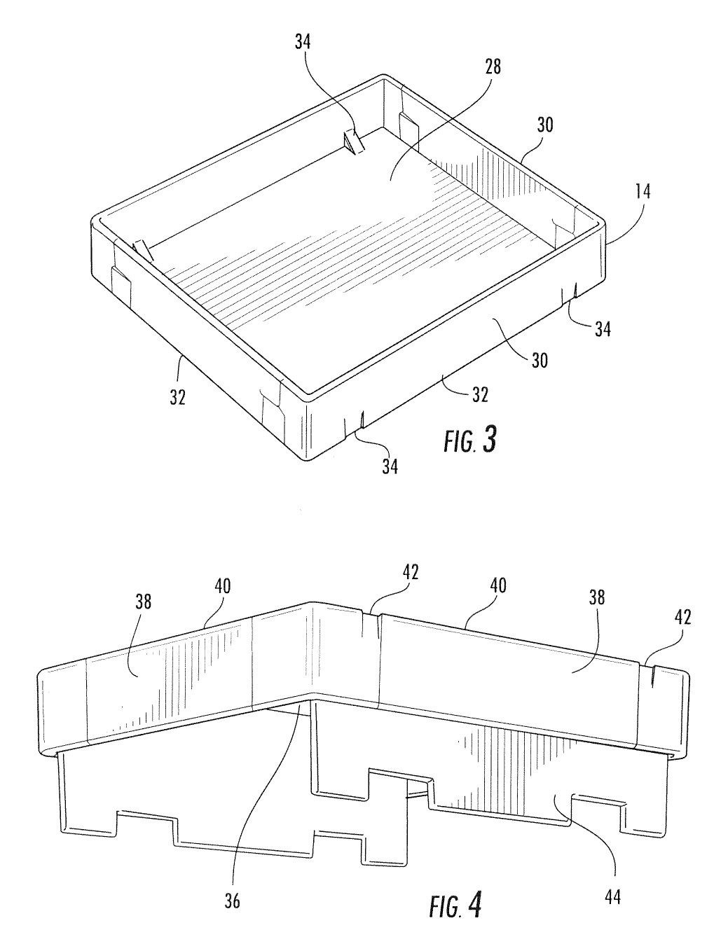

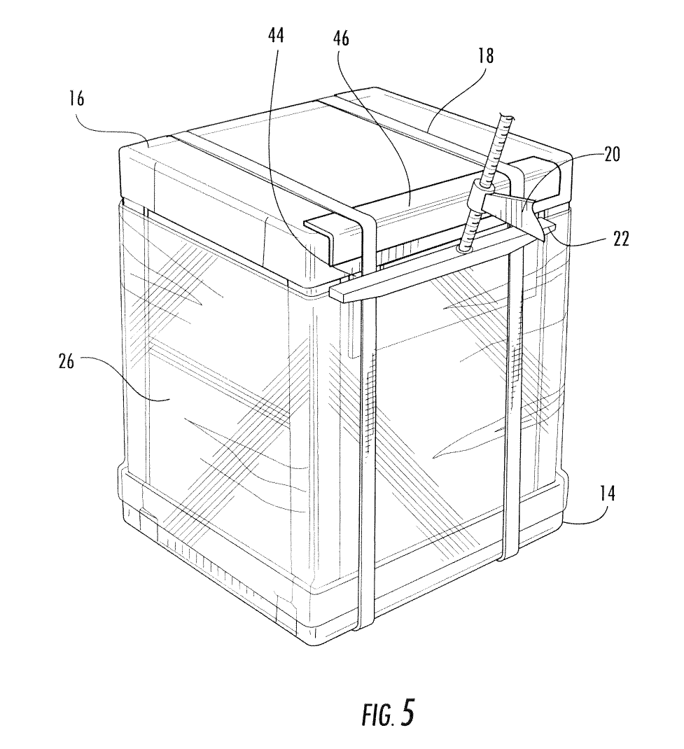

The top tray 16 of the present invention is shown in more detail in FIG. 4. In one embodiment of the present invention, the top tray 16 includes a base portion 36 for protecting the topside of the product 12 and a plurality of edge portions 38 extending from the base portion 36 of the top tray 16 to fit atop the product 12. The base portion 36 and the edge portions 38 of the top tray 16 cooperate to form a plurality of horizontal top tray corners 40. The edge portions 38 and the base portion 36 are both sized to fit any desired product 12. It should be understood that the edge portions 38 can be any desired length based up on the product's 12 dimensions and desired amount of material used to construct the edge portions 38 of the top tray 16.

In another embodiment of the present invention, the top tray 16 is further provided with at least one notch portion 42 disposed on at least one of the plurality of horizontal top tray corners 40 for receiving the banding 18. In another embodiment of the present invention, there are a plurality of notch portions 42 symmetrically disposed on a plurality of horizontal top tray corners 40 so the banding 18 is symmetrically disposed about the product 12. In one example, there are two notch portions 42 on one of the horizontal top tray corners 40 and two notch portions 42 symmetrically disposed on another one of the horizontal top tray corners 40 on the opposite side of the product 12. This permits the banding 18 to be symmetrically disposed about the product 12 and prohibits the banding 18 form sliding out of position or off the product 12, thus providing balance to the clear-view packaging system 10.

It should be understood and appreciated that, in another embodiment of the present invention, the notch portions 42 of the horizontal top tray corners 40 and the notch portions 34 of the horizontal bottom tray corners 32 are aligned to permit the banding 18 to be securely around the product 12.

In a further embodiment of the present invention, the clear-view packaging system 10 is provided with at least one product protection member 44 for protecting the product 12 from the lifting member 22 of the lift vehicle 20. The product protection member 44 is disposed between one of the edge portions 38 of the top tray 16 and the product 12 creating an area between the edge portion 38 of the top tray 16 and the product protection member where the lifting member 22 can be positioned in order to lift the product 12 and move it to desired locations. The product protection member 44 can be any length or size such that it protects the product 12 from the lifting member 22 of the lift vehicle 20. The product protection member 44 can also be constructed out of any material known in the art so that it is capable of protecting the product 12 from the lifting member 22 of the lift vehicle 20 product 12 from the lifting member 22 of the lift vehicle 20. Examples of material include, but are not limited to, cardboard, any paper based material, polymer based material, wood based material, metal based material, and the like. In another embodiment of the present invention, the product protection member 44 can be attached to and supported by the top tray 16. The clear-view packaging system 10 can also be equipped with a support member disposed between the product protection member 44 and the product to provide further protection to the product 12. A piece of Styrofoam can be used to construct the support member. Any type of material known in the art can be used to construct the support member.

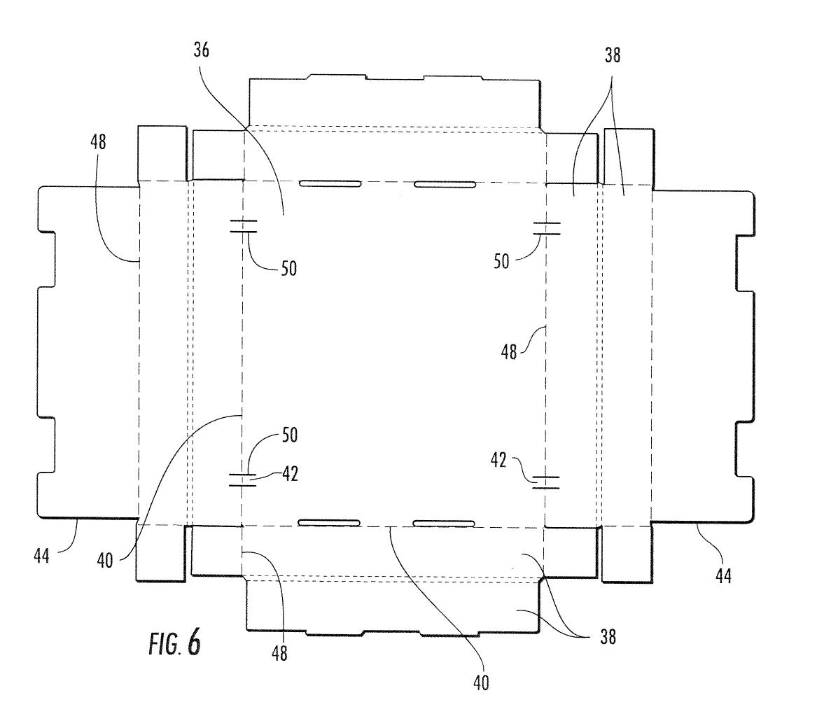

In a further embodiment of the present invention, shown in FIG. 5 is the clear-view packaging system 10 that further includes at least one angle board 46 to reinforce the horizontal top tray corners 40. The angle boards 46 can also include notches to similar to the notch portions 42 of the top tray 16 described herein.

In yet another embodiment of the present invention, the top tray 16 of the present invention is constructed from a single piece of material. The top tray 16 of this embodiment is shown in more detail in FIG. 6. In this embodiment of the present invention, material to form the base portion 36, the edge portions 38, the horizontal top tray corners 40, and, optionally, the notch portions 42 and the product protection member 44 are all included in one piece of material that can be manipulated to form the top tray 16. FIG. 6 shows the one piece top tray 16 having fold lines 48 (dashed lines) where the one piece top tray 16 is folded to create the top tray 16 described herein. The one piece top tray 16 can also be provided with slits 50 to create the notch portions 42 of the top tray 16.

The material used to construct the bottom tray 14 and the top tray 16 can be any material known in the art for packaging and shipping products. Examples of material that can be used to construct the bottom tray 14 and the top tray 16 include, but are not limited to, cardboard, any paper based material, polymer based material, wood based material, metal based material, and the like.

From the above description, it is clear that the present invention is well adapted to carry out the objects and to attain the advantages mentioned herein as well as those inherent in the invention. While presently preferred embodiments of the invention have been described for purposes of this disclosure, it will be understood that numerous changes may be made which will readily suggest themselves to those skilled in the art and which are accomplished within the spirit of the invention disclosed and claimed.

What is claimed is:

1. A clear-view packaging system for packaging a product, the clear-view packaging system comprising:
a bottom tray for receiving the product, the bottom tray having a base portion and a plurality of edge portions;
a top tray disposed on the top of the product, the top tray having a base portion, a plurality of edge portions and a plurality of horizontal top tray corners; and
at least one strip of banding for securing the bottom tray, the product and the top tray together wherein a lifting member of a lift vehicle can be positioned between at least one of the plurality of edge portions of the top tray and the product so that the product can be lifted and transported.

2. The system of claim 1 wherein the top tray and the bottom tray are each provided with at least one notch for receiving and stabilizing the at least one strip of banding.

3. The system of claim 1 wherein the clear-view packaging system is further provided with a plurality of vertical support members to support the top tray and distribute the weight and pressure resulting from by any object stacked upon the product onto the vertical support members.

4. The system of claim 1 wherein the clear-view packaging system is further provided with at least one angle board disposed on at least one of the horizontal top tray corners.

5. The system of claim 1 wherein the top tray is constructed of a single sheet of material that is folded into the top tray.

6. The system of claim 1 wherein the top tray is further provided with a product protection member that extends further along the product than one of the edge portions of the top tray to protect the product from the lifting member of the lift vehicle.

7. The system of claim 1 wherein the clear-view packaging system is further provided with a protective layer to protect the product from the various elements while being shipped and stored.

8. The system of claim 7 wherein protective layer is constructed of a transparent material.

9. A method of packaging a product, the method comprising the steps of:
providing a product to be packaged;
providing a bottom tray for receiving the product, the bottom tray having a base portion and a plurality of edge portions;
disposing a top tray on top of the product, the top tray having a base portion, a plurality of edge portions and a plurality of horizontal top tray corners; and
providing at least one strip of banding around the bottom tray, the product and the top tray to secure them together wherein a lifting member of a lift vehicle can be positioned between at least one of the plurality of edge portions of the top tray and the product so that the product can be lifted and transported.

10. The method of claim 9 wherein the top tray and the bottom tray are each provided with at least one notch for receiving and stabilizing the at least one strip of banding.

11. The method of claim 9 wherein the clear-view packaging system is further provided with a plurality of vertical support members to support the top tray and distribute the weight and pressure resulting from by any object stacked upon the product onto the vertical support members.

12. The method of claim 9 wherein the clear-view packaging system is further provided with at least one angle board disposed on at least one of the horizontal top tray corners.

13. The method of claim 9 wherein the top tray is constructed of a single sheet of material that is folded into the top tray.

14. The method of claim 9 wherein the top tray is further provided with a product protection member that extends further along the product than one of the edge portions of the top tray to protect the product from the lifting member of the lift vehicle.

15. The method of claim 9 wherein the clear-view packaging system is further provided with a protective layer to protect the product from the various elements while being shipped and stored.

16. The method of claim 15 wherein protective layer is constructed of a transparent material.
